(19) United States
(12) Patent Application Publication
(10) Pub. No.: US 2009/0309972 A1
(43) Pub. Date: Dec. 17, 2009

(54) Drive recorder and system

(75) Inventors: Fujio Tonokawa, Kobe-shi (JP); Minoru Yoshimura, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-Shi (JP)

(21) Appl. No.: 12/457,435

(22) Filed: Jun. 10, 2009

(30) Foreign Application Priority Data
Jun. 13, 2008 (JP) 2008-155805

(51) Int. Cl. H04N 7/18

(52) U.S. Cl. 348/148; 348/E07.085

(57) ABSTRACT

It is an object to provide a drive recorder and a system that that can reduce operations for adjusting an attachment position of a camera. The drive recorder for recording images captured by a camera in a recording medium includes, mode selection means for selecting an angle adjustment mode of the camera, and a control unit for outputting image data based on the images to a display unit (120) when the mode selection means selects the angle selection mode. The system includes such a drive recorder.

This application is a new U.S. patent application that claims priority of Japanese Application No. 2008-155805, filed Jun. 13, 2008, the content of which is incorporated herein by reference.

### FIELD OF TEE INVENTION

The present invention relates to a drive recorder and a system and, in particular, relates to a drive recorder and a system that allows a camera angle to be easily adjusted.

### BACKGROUND OF THE INVENTION

A technique is known in which a capturing direction of a vehicle camera is adjusted by comparing a determination pattern with an image of a predetermined test chart captured by the camera that is provided in a vehicle parked in the near the test chart. (See Patent Literature 1.)

Further, there is also known a drive recorder that stores captured information from a video camera mounted in a vehicle in a loop so that images captured at the time of an accident can be stored. (See Patent Literature 2.)

In the drive recorder of this type in which the camera captures images, an attachment angle of the camera has to be adjusted in advance to obtain an appropriate capturing range of the camera. For example, when capturing images in front of the vehicle, the camera is fixed to an inner surface of a windshield, a rearview mirror or the like. In this case, it is difficult to appropriately adjust the angle of the camera if the actual captured scene cannot be viewed simultaneously.

The drive recorder records the captured images on a memory card once, but some drive recorders do not have a function to output the images recorded on a memory card from the main unit of the drive recorder to the outside. In these models, the adjustment of the attachment angle of the camera is very troublesome because it is necessary to repeat a series of operations comprising: recording the images on the memory card once; removing the memory card from the drive recorder and inserting it into a personal computer or the like; reproducing the recorded images on the personal computer to check the capturing range of the camera; and then, adjusting the attachment angle, etc.

On the other hand, some drive recorders have the function of outputting images recorded on a memory card from the main unit-of the drive recorder to the outside. In these models, after the camera is attached to a predetermined position, it is necessary to repeat a series of operations comprising: entering a recording mode to record the images for a predetermined time period on the memory card; and then, entering a reproduction mode for reproducing the recorded images to display the images on a display or the like and check the attachment position of the camera. Also in drives recorders that have the function of outputting the images recorded on the memory card from the main unit of the drive recorder to the outside, in addition to switching between the recording mode and the reproduction mode, it takes time to check the reproduced images because a predetermined time (typically, 20-30 seconds) is necessary to record the images on the memory card, etc. Thus, in these drive recorders, the adjustment of the attachment angle of the camera is very time consuming and troublesome because it is necessary to repeat a series of operations comprising; recording the images for a few seconds; reproducing the images; and then, adjusting the attachment angle of the camera.

Patent Document 1: Japanese unexamined Patent Publication No. 2001-91984 (FIG. 7)

Patent Document 2: Japanese unexamined Patent Publication No. S63-16785 (FIG. 1)

### SUMMARY OF THE INVENTION

It is an object of the present invention to provide a drive recorder and a system that can reduce troublesomeness of operations for adjusting an attachment position of a camera.

According to the present invention, there is provided a drive recorder for recording images captured by a camera in a recording medium, including; mode selection means for selecting an angle adjustment mode of the camera; and a control unit for controlling so that image data based on the images is output to a display unit when the mode selection means selects the angle selection mode.

Further, according to the present invention, there is provided a system including, a camera for capturing images by using a frequency that is not affected by flashing of an LED traffic light due to a commercial power frequency, a display unit that operates based on a standard frequency, and a drive recorder for recording the images captured by said camera in a recording medium, wherein the drive recorder includes, mode selection means for selecting an angle adjustment mode of the camera, and a control unit for controlling so that image data based on said images is output to said display unit when said mode selection means selects the angle selection mode.

The drive recorder and the system according to the present invention has the angle adjustment mode and, in the angle adjustment mode, the output from the camera can be displayed on the display unit directly or intermittently, so that, substantially, the angle of the camera can be easily adjusted while viewing video captured by the camera.

### DESCRIPTION OF THE DRAWINGS

These and other features and advantages of the present invention will be better understood by reading the following detailed description, taken together with the drawings wherein:

FIG. 1 is a block diagram illustrating a schematic configuration of a system including a drive recorder;

FIG. 2 is a diagram illustrating an example of how a camera 110 is attached;

FIG. 3 is a diagram illustrating an example in which a drive recorder 100 is mounted in a vehicle 1;

FIG. 4 is a perspective view of a main body of drive recorder 100;

FIG. 5 is a diagram illustrating an example of a main process flow of drive recorder 100;

FIG. 6 is a diagram illustrating an example of a process flow in a reproduction mode;

FIG. 7 is a diagram illustrating an example of a process flow in a normal operation mode;

FIG. 8 is a diagram illustrating an example of a process flow in an angle operation mode;

FIG. 9 is a diagram illustrating a schematic configuration of a variation of the system illustrated in FIG. 1;

FIG. 10(a) is a diagram illustrating a first relationship between traffic light flashing and image capture timing, and FIG. 10(b) is a diagram illustrating a second relationship between traffic light flashing and image capture timing;

FIG. 11 is a diagram illustrating an example of a flashing state of a traffic light in captured images;

FIG. 12 is a diagram illustrating a schematic configuration of another system including a drive recorder according to the present invention;

FIG. 13 is a diagram illustrating an example of a process flow in a reproduction mode corresponding to drive recorder 150 illustrated in FIG. 12;

FIG. 14 is a diagram illustrating an example of a process flow in a normal operation mode corresponding to drive recorder 150 illustrated in FIG. 12;

FIG. 15 is a diagram illustrating an example of a process flow in an angle adjustment operation mode corresponding to drive recorder 150 illustrated in FIG. 12;

FIG. 16(a) is a diagram illustrating an example of image data recorded in a memory card, and FIG. 16(b) is a diagram illustrating an example of reproduced image data;

FIG. 17 is a diagram illustrating a schematic configuration of yet another system including a drive recorder;

FIG. 18 is a diagram illustrating an example of a process flow in an angle adjustment mode corresponding to drive recorder 160 illustrated in FIG. 12;

FIG. 19(a) is a diagram illustrating an example of image data recorded in a memory card, and FIG. 19(b) is a diagram illustrating an example of reproduced image data; and

FIG. 20 is a diagram illustrating a schematic configuration of yet another system including a drive recorder.

### DETAILED DESCRIPTION OF THE PREFERRED EMBODIMENT

A drive recorder will be described below with reference to drawings. It should, however, be noted that the technical scope of the present invention is not limited to the specific embodiments described herein, but extends to the inventions described in the appended claims and their equivalents.

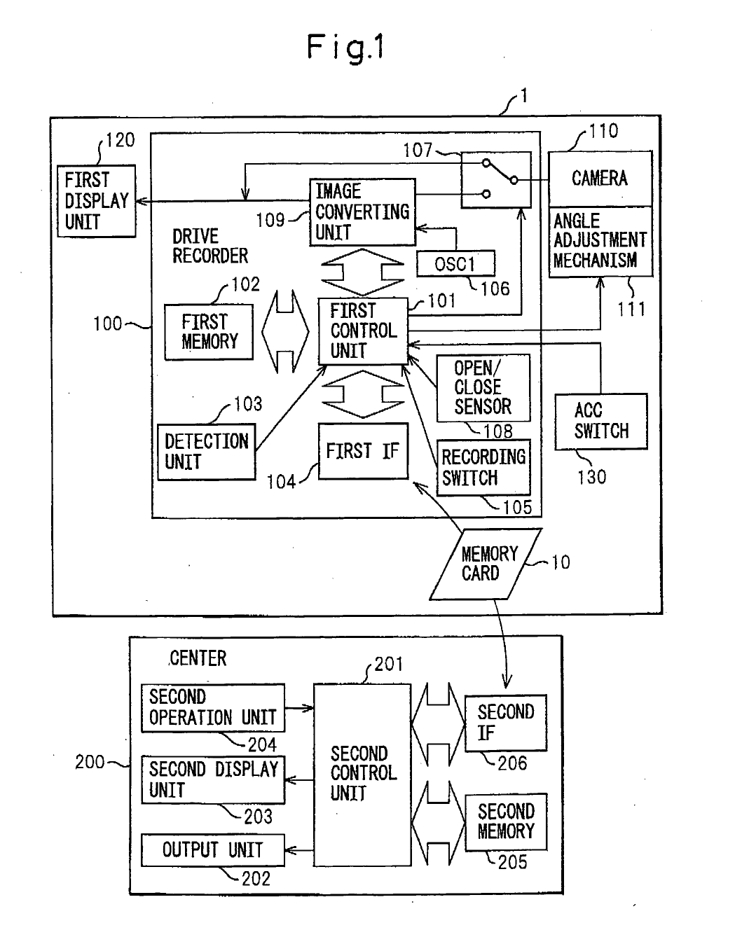

FIG. 1 is a block diagram illustrating a schematic configuration of a system including a drive recorder.

The system includes, in addition to drive recorder 100 mounted in a vehicle 1, a camera 110, an angle adjustment mechanism 111 for adjusting an angle of the camera, a first display unit 120 constituted by an LCD monitor or the like that is driven at a frequency corresponding to that of a standard video signal, an accessory switch (ACC switch) 130, a memory card 10 for storing images recorded when a recording condition described later holds in drive recorder 100, and a center terminal 200 for reproducing the images stored in memory card 10. Drive recorder 100 may be constructed so as to include camera 110 and/or first display unit 120. A display unit of a navigation system may be used as first display unit 120. Further, drive recorder 100 may be incorporated into the navigation system containing first display unit 120. Still further, ACC switch 130 is constructed to be electrically integrated with a key cylinder for engine start up that is provided in vehicle 1.

The drive recorder 100 includes a first control unit 101 comprising a CPU, ROM, RAM, etc., a first memory 102 comprising a RAM, etc., for temporarily storing images, a detection unit 103 constituted by a G (acceleration) sensor, a vehicle speed sensor or the like for detecting a driving status of the vehicle., a first memory card IF (interface) 104, having a slot into which memory card 10 is inserted, for performing operations such as writing images to memory card 10, a recording switch 105, a first frequency oscillator 106 corresponding to the frequency of the video signal received from camera 110, a changeover switch 107 for directing the video signal from camera 110 to a selected output, an open/close sensor 108 that interlocks with an open/close knob 11 of the first memory card IF, and an image converting unit 109 for converting the video signal received from camera 110 into still image data to be recorded, and then, converting the still image data into the video signal to be output to first display unit 120. Two independent image converting units 109 may be provided for performing the conversion into the still image data and the conversion into the video data, respectively.

The G sensor included in detection unit 103 detects gravitational acceleration in two axis directions (X axis and Y axis) perpendicular to each other. The G sensor is mounted inside the vehicle so that the direction (positive direction) of the Y axis of the G sensor coincides with the forward direction of the vehicle and the direction (positive direction) of the X axis of the G sensor coincides with the rightward direction of the vehicle. Accordingly, based on the detection signal G (Gx, Gy) output from the G sensor, first control unit 101 can determine whether an impact has been applied to the vehicle and from which direction the impact has been applied to the vehicle. Gx represents the gravitational acceleration in the X-axis direction, and Gy the gravitational acceleration in the Y-axis direction.

Recording switch 105 is attached to drive recorder 100 and used to trigger various modes. For example, as described later, when recording switch 105 is turned ON just after starting the engine, an angle adjustment mode of camera 110 is started. On the other hand, when recording switch 105 is turned ON after a predetermined time period from engine start up, predetermined images are recorded on the memory card.

Camera 110 comprises a CCD camera that captures images at a frequency corresponding to the standard video signal and outputs a video signal based on the thus captured images. More specifically, a standard video signal frequency (59.94 Hz) of the NTSC standard is used as the standard video signal frequency. Other frequencies such as those of the PAL standard or the like may be used as the standard video signal.

First display unit 120 comprises the LCD monitor that displays the video signal output at the frequency corresponding to the standard video signal. More specifically, similar to camera 110, the standard video signal frequency (59.94 Hz) of the NTSC standard is used as the standard video signal frequency. An onboard monitor for displaying navigation or TV programs may be used as first display unit 120.

First control unit 101 allows changeover switch 107 to switch the video output from camera 110 to either image converting unit 109 or first display unit 120. When changeover switch 107 switches the video output from camera 110 to image converting unit 109, the video output is recorded in first memory 102 in a circulating and continuous manner and, on the other hand, when the video output from camera 110 is switched to first display unit 120, the video output can be displayed directly on first display unit 120.

The center terminal 200 includes a second control unit 201 comprising a CPU, ROM, RAM, etc., an output unit 202 constituted by a printer or the like, a second display unit 203 constituted by a display or the like, a second operation unit 204 comprising a keyboard, mouse, etc., a second memory 205 for temporarily storing images, and a second memory card IF (interface) 206 having a slot into which memory card 10 is inserted to perform operations such as reading images from the memory card 10. Center terminal 200 may be implemented as a personal computer having functions equivalent to the above functions.

Memory card 10 is constituted by an SD card (secure digital memory card) which is a recording medium removable from drive recorder 100 and is a programmable nonvolatile semiconductor memory card video information and vehicle operational information described below is recorded in memory card 10. Memory card 10 is provided with a DIP switch that can be manipulated to write-protect memory card 10.

An SD card is used as memory card 10 in this embodiment, but alternatively, another removable memory card (such as a CF card (compact flash card) or a memory stick) or a hard disk or the like may be used.

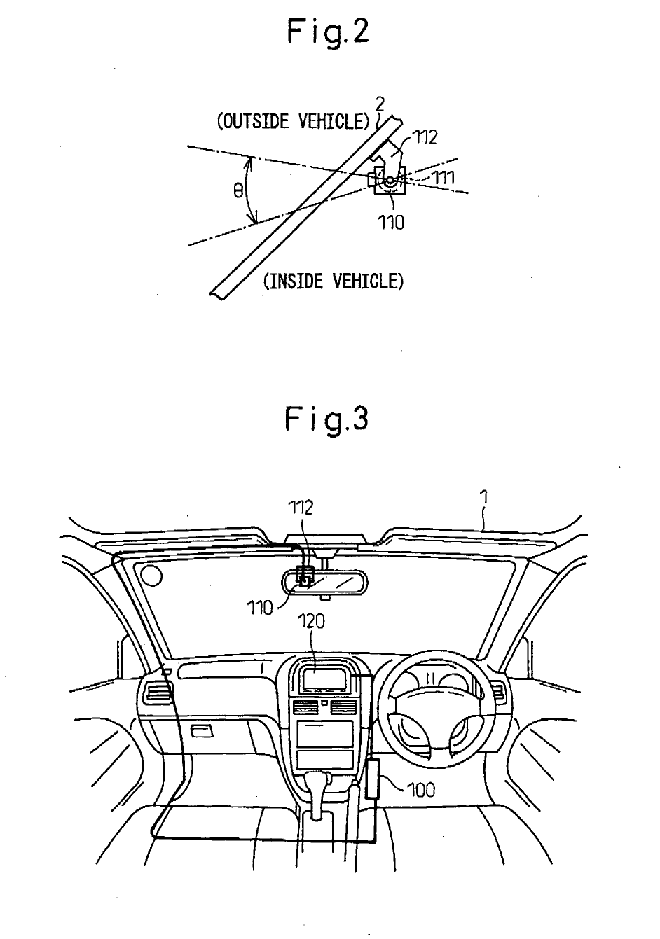

FIG. 2 is a diagram illustrating an example of how camera 110 is attached.

Camera 110 is pivotally supported by a bracket 112 that is adhered to the inner surface of a windshield 2 of vehicle 1 (inside the vehicle). Angle adjustment mechanism 111 constituted by a motor and gears or the like is disposed in a housing of camera 110, so that the center of the capturing direction of camera 110 can be adjusted up or down within a range of angle θ based on the control signal from first control unit 101 of drive recorder 100. In order to not obstruct a driver's view, camera 110 is preferably disposed at a position within upper 20% of windshield 2.

Angle adjustment mechanism 111 of camera 110 is configured to adjust only the up and down direction of camera 110 in the example of FIG. 2, but it may be configured to adjust not only the up and down direction but also the left and right direction.

FIG. 3 is a diagram illustrating an example in which drive recorder 100 is mounted in vehicle 1.

Drive recorder 100 is secured to an edge of a center panel at the lower left side of a steering wheel, for example, and electrically connected with camera 110, ACC switch 130 (not illustrated) or the like. Camera 110 is pivotally supported by bracket 112 on the inner surface of the windshield behind a rearview mirror. FIG. 3 illustrates a case in which the vehicle's display unit is used as first display unit 120.

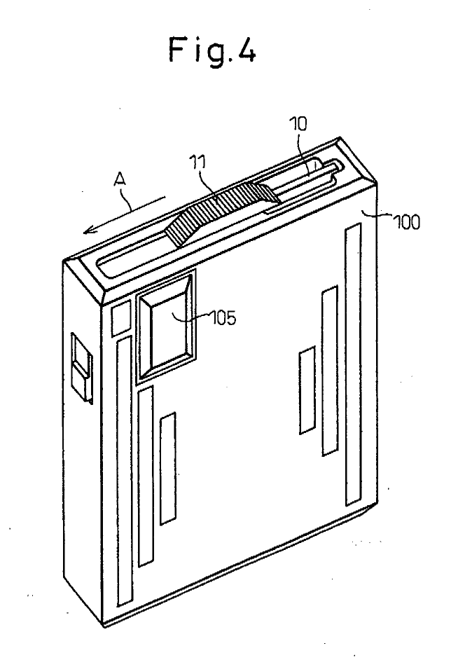

FIG. 4 is a perspective view of a main body of drive recorder 100.

Drive recorder 100 has recording switch 105, an open/close sensor 108 (not illustrated), open/close knob 11 and so on.

After memory card 10 is inserted into the slot that constitutes first IF 104 described later, open/close knob 11 slides to be positioned above memory card 10 to protect it (in the situation of FIG. 4). When memory card 10 is removed, open/close knob 11 slides in the direction of arrow A. Further, drive recorder 100 has open/close sensor 108 that interlocks with open/close knob 11, so as to output OFF signal indicating the closed state when open/close knob 11 is positioned above memory card 10 (in the state of FIG. 4) and to output ON signal indicating the opened state when memory card 10 can be removed.

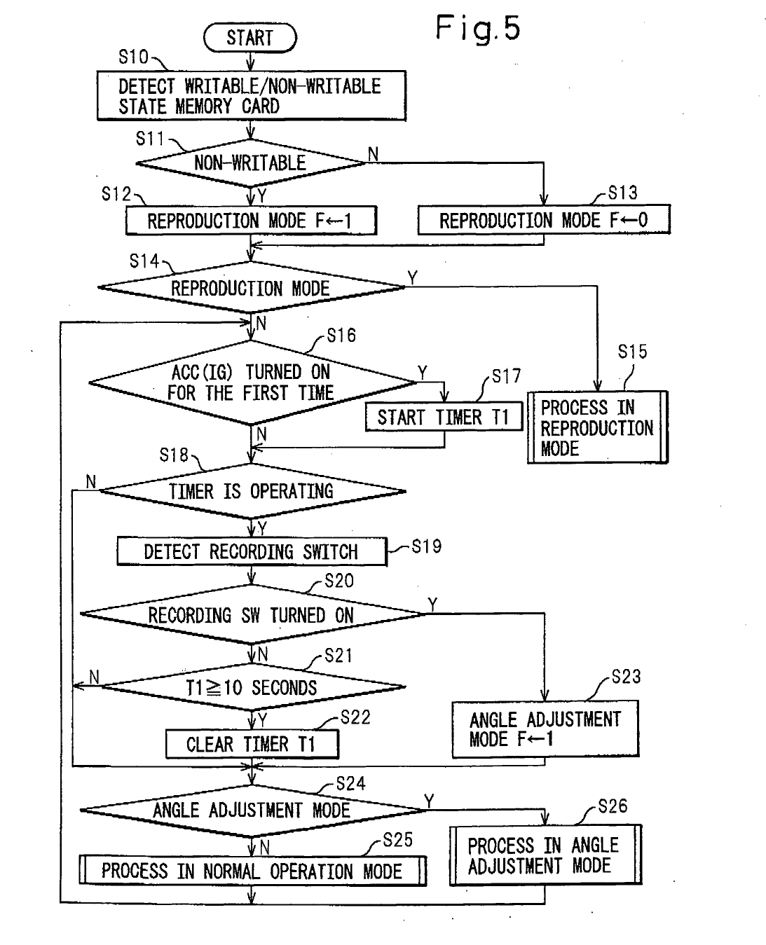

FIG. 5 is a diagram illustrating an example of a main process flow of drive recorder 100.

It is assumed that the process flow illustrated in FIG. 5 is performed by first control unit 101 of drive recorder 100 in cooperation with the components of drive recorder 100, angle adjustment mechanism 111, first display unit 120, ACC switch 130 and so on according to a program preliminarily stored in the ROM or the like of first control unit 101, and it is also assumed that, when the process flow illustrated in FIG. 5 starts, the components of drive recorder 100, angle adjustment mechanism 111, first display unit 120, ACC switch 130 and so on are energized and ready to be driven.

First, based on a signal from first IF 104, first control unit 101 detects a writable/non-writable state of memory card 10 (S30). First IF 104 outputs the signal according to the position of the DIP switch of memory card 10 described above to first control unit 101. Based on the signal according to the position of the DIP switch of memory card 10, first control unit 101 can detect the writable/non-writable state of memory card 10.

Next, first control unit 101 determines whether the non-writable state has been detected or not in S10 and, if the non-writable state has been detected, a reproduction mode flag (reproduction mode F) is set to “1” (S12) and, if the writable state has been detected in S10, the reproduction mode F is set to “0” (S13).

Next, first control unit 101 determines whether the reproduction mode F is “1” or not (S14) and, if the reproduction mode F is “1”, the process proceeds to step S15 to enter the reproduction mode. In other words, when memory card 10; whose DIP switch is set to the non-writable position, is inserted into drive recorder 100, the process enters the reproduction mode. This reproduction mode will be described later.

If the reproduction mode F is “0” in step S14, based on a signal from ACC switch 130, first control unit 101 determines whether ACC switch has been turned ON for the first time since drive recorder 100 was energized or not (S16). This determination may be made based on an ignition signal (IG).

If it is determined that ACC switch 130 has been turned ON for the first time in S16, a timer T1 is started to measure elapsed time since ACC switch was turned ON (S17).

If it is determined that ACC switch 130 has been turned ON not for the first time in S16, first control unit 101 determines whether timer T1 is operating or not (518), and then, if timer T1 is operating, first control unit 101 detects recording switch 105 (S19) and if timer T1 is not operating, the process proceeds to S24.

Next, first control unit 101 determines whether recording switch 105 has been turned ON in S19 or not (S20) and if recording switch 105 has been turned ON, an angle adjustment mode flag (angle adjustment mode F) is set to “1”.

If it is determined that recording switch 105 has not been turned ON in S20, it is determined whether the elapsed time of timer T1 is 10 seconds or more or not (S21) and, if the elapsed time is 10 seconds or more, timer T1 is cleared (322).

Next, first control unit 101 determines whether the angle adjustment mode F has been set to “1” or not (S24) and, if the reproduction mode F has not been set to “1”, the process proceeds to step S25 to enter the normal operation mode and, if the reproduction mode F has been set to “1”, the process proceeds to step S26 to enter the angle adjustment mode. After the process is completed in any mode, it returns to S16 again to be similarly repeated. The normal operation mode and the angle adjustment mode will be described later.

As set forth in S16-S26, when recording switch 105 has been turned ON within the time period after the ACC switch had been turned ON for the first time till timer Ti was up (10 seconds in the process flow in FIG. 5) or, in other words, when recording switch 105 of drive recorder 100 has been turned ON within 10 seconds since drive recorder 100 was energized or drive recorder 100 started to operate, the process enters the angle adjustment mode. The 10 seconds in the process flow of FIG. 5 is merely an example and other time periods may be selected. Further, alternatively, a dedicated switch for entering the angle adjustment mode may be provided, so that the process can enter the angle adjustment mode when the dedicated switch is turned ON. In this case, the process concerning the timer as set forth in S16-S22 is unnecessary and instead the angle adjustment mode F may be set to “1” when the dedicated switch is turned ON.

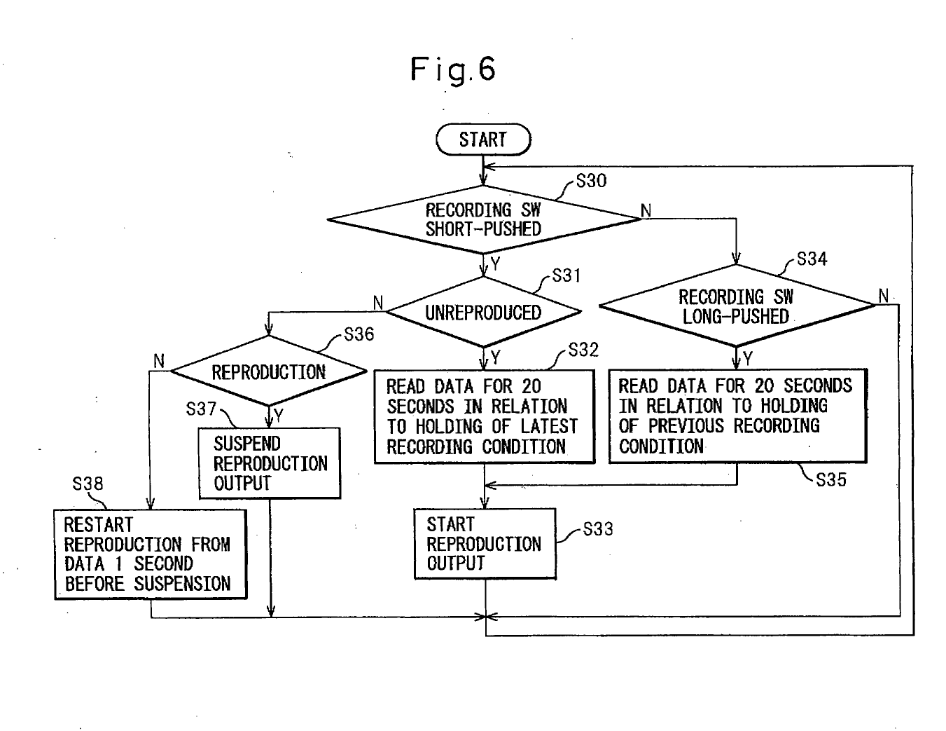

FIG. 6 is a diagram illustrating an example of a process flow in the reproduction mode.

In the reproduction mode illustrated in FIG. 6, the process in S15 of FIG. 5 is described in more detail. First, first control unit 101 determines whether recording switch 105 has been “short-pushed” or not (S30). The term “short-push” means that recording switch 105 is pushed only once for a short time period (for example, 1 second or less).

If it is determined that recording switch 105 has been “short-pushed” in S30, then, first control unit 101 determines whether the images recorded in memory card 10 at present are unreproduced or not (S31). The term “unreproduced” means that the images have never been reproduced since the process entered the reproduction mode.

If it is determined that the images are unreproduced in S31, then, data for 20 seconds in relation to the holding of the latest recording condition is read from the memory card into the first memory (S32) and, then, image converting unit 109 converts the read images into a reproduction output signal and outputs it to first display unit 120 (S33). As a result, on first display unit 120, the user can check the images recorded in the memory card 10.

Drive recorder 100 is configured to record a series of images for 20 seconds in memory card 10 when the recording condition described later holds. Further, typically, corresponding to a plurality of (for example, 15) recording conditions, the plurality of the series of images each for 20 seconds can be recorded in one memory card. Hence, in step S33, it is configured that the images for 20 seconds recorded upon the holding of the latest recording condition can be output.

If it is determined that recording switch 150 has not been “short-pushed” in S30, then, it is determined whether recording switch 150 has been “long-pushed” or not (S34). The term “long-push” means that recording switch 105 is pushed continuously for a predetermined time period (for example, 2 seconds) or more.

If it is determined that recording switch 105 has been “long-pushed” in S34, then, first control unit 101 reads the data for 20 seconds in relation to the holding of the one just before the latest recording condition from the memory card into the first memory (S35) and image converting unit converts the read images into a reproduction-output signal and outputs it to first display unit 120 (S33). As a result, the user can check the images recorded in the memory card 10 on first display unit 120. If first control unit 101 cannot determine whether recording switch 105 has been “short-pushed” or “long-pushed”, the process returns to S30 again to repeat the subsequent steps.

Thus, the process flow of the reproduction mode illustrated in FIG. 6 is configured so that the “short-push” results in the reproduction of the images upon the holding of the latest recording condition, and on the other hand, the “long-push” results in the reproduction of the images upon the holding of one just before the latest recording condition. Further, by repeating the “long-push”, older recorded images can be reproduced.

On the other hand, it is determined that the images are not unreproduced (that is to say, the images are being reproduced or the reproduction is suspended) in S31, then, first control unit 101 determines whether the images are being reproduced or not (S36) and, if it is determined that the images are being-reproduced, the reproduction output is suspended (S37). On the other hand, if it is determined that the images are not being reproduced (i.e., the output images are suspended), the reproduction starts again from the point in time 1 second before the suspension (S38).

Thus, if recording switch 105 is “short-pushed” again during the reproduction, the reproduction is suspended and, on the other hand, recording switch 105 is “short-pushed” during the suspension of the reproduction, the reproduction starts again from the point in time 1 second before the suspension. As described above, the operations in the reproduction mode are configured so that one recording switch 105 can be used effectively. Here, alternatively, a dedicated switch for the reproduction may be provided to control the reproduction.

In the case such as when open/close sensor 108 detects that open/close knob 11 is opened and moved to the position where memory card 10 can be removed or when recording switch 105 has not been manipulated for a predetermined time period (for example, 30 seconds) after the process entered the reproduction mode, drive recorder 100 is reset to restart the main process flow illustrated in FIG. 5 and, as a result, the reproduction mode illustrated in FIG. 6 terminates. Here, unless memory card is once removed to set the DIP switch to the writable position, the reproduction mode will be restarted.

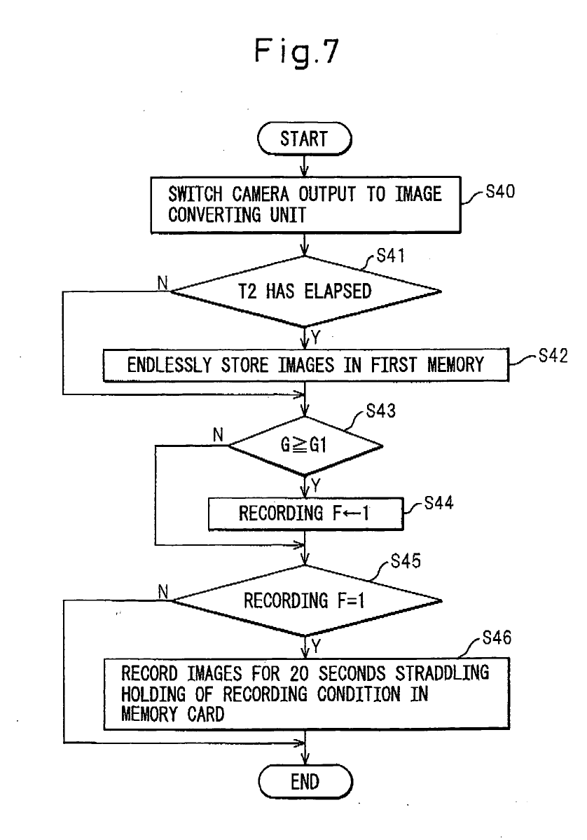

FIG. 7 is a diagram illustrating an example of a process flow in the normal operation mode.

In the normal operation mode illustrated in FIG. 7, the process in S25 of FIG. 5 is described in more detail. First, first control unit 101 operates changeover switch 107 to switch the output of camera 110 to image converting unit 109 (S40).

Next, first control unit 101 determines whether a timer time T2 that was started at a predetermined timing has elapsed or not (S41) and, if timer time T2 has elapsed, image converting unit 109 converts analog video data from camera 110 into digital still image data of the JPEG standard and stores it in first memory 102 in a circulating and continuous manner (S42). Timer time T2 corresponds to the timing to capture the images. For example, when data for 10 still images per second is recorded in first memory 102, timer time T2 is set to 100 ms and it is determined whether the image capture has been performed or not in S41. Thus, in this case, in drive recorder 10, data for 10 still images per second are recorded in first memory 102 in a circulating and continuous manner.

Then, first control unit 101 determines whether an acceleration value G detected by detection unit 103 is greater than or equal to a threshold value G1 or not (S43). Acceleration value G can be obtained by (Gx²+Gy²)^{0.5}. Further, for example, threshold value G1 may be set to 0.4 G that is an acceleration value when an impact corresponding to an accident is applied to vehicle 1.

Thus, in S43, when an impact corresponding to an accident has been applied to vehicle 1, the recording condition is considered to hold and a recording flag (recording F) is set to “1”. The case when the acceleration sensor has detected acceleration G greater than or equal to threshold value G1 as described above refers to the “G detection”. In addition to “the G detection”, the recording condition may be considered to hold and the recording F may be set to “1” in the following two cases.

The case when the recording condition holds (2)—“the speed trigger”: it holds when speed variation of vehicle 1 detected by a vehicle speed sensor (not illustrated) during a predetermined time period is greater than or equal to a threshold value. More specifically, the recording condition is considered to hold when vehicle 1 running at 60 km/h or more decelerates at a rate of 14 km/h or more per second. The recording condition may be considered to hold in such case because such speed variation of vehicle 1 may be recognized as occurrence or imminence of an accident. The above set values (when running at 60 Km/h or more, the deceleration occurs at the rate of 14 km/h or more) are merely an example and other values may be adopted.

The case when the recording condition holds (3)—“the recording switch”: it holds when recording switch 105 has been pushed 10 seconds or more after ACC switch 130 was turned ON. (See S18-S23 of FIG. 5.)

Further, in addition to the 3 cases described above, 1 still image may be recorded in memory card 10 at predetermined intervals (for example, every second).

Next, first control unit 101 determines whether the recording F is “1” or not (S45), if the recording F is “1”, the data of the still images for 20 seconds straddling the holding of the recording condition among those recorded in first memory 102 in a circulating and continuous manner is recorded in memory card 10. For example, in response to the holding of one recording condition, the data of 120 still images for 12 seconds before the holding of such recording condition and 80 still images for 8 seconds after the holding of such recording condition is recorded in memory card 10.

Then, after the still image data has been recorded in memory card 10, first control unit 101 sets the recording F to “1” and terminates the process flow of the normal operation mode. After the termination of the normal operation mode, the process returns to the main process flow illustrated in FIG. 5 to repeat S16 and following steps.

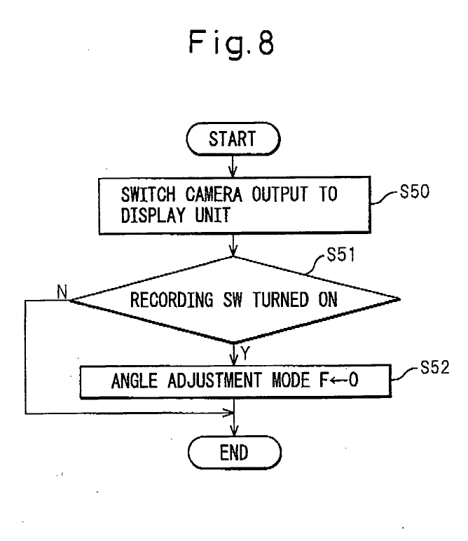

FIG. 8 is a diagram illustrating an example of a process flow in the angle operation mode.

In the angle adjustment mode illustrated in FIG. 8, the process in S26 of FIG. 5 is described in more detail. First, first control unit 101 operates changeover switch 107 to switch the output of camera 110 to display unit 120 (S50).

Next, first control unit 101 determines whether recording switch 105 has been turned ON or not (S51) and, if recording switch 105 has been turned ON, in order to terminate the angle adjustment mode, the angle adjustment mode F is set to “0” (S52) and terminates the process flow of the angle adjustment mode.

Then, after the termination of the angle adjustment mode, the process returns to the main process flow illustrated in FIG. 5 to repeat S16 and following steps.

Thus, when recording switch 105 has been turned ON within the time period after the ACC switch had been turned ON for the first time till timer T1 was up (10 seconds in the process flow in FIG. 5), the process enters the angle adjustment mode, and when recording switch 105 is turned ON again after entering the angle adjustment mode (see S51), the angle adjustment mode terminates.

In drive recorder 100, during the angle adjustment mode, the video output of camera 110 can be observed directly on first display unit 120 (for example, the vehicle monitor), and at the same time, angle adjustment mechanism 111 can be operated by using buttons or touch-sensitive input means and the like (not illustrated) provided in drive recorder 100 so as to appropriately adjust the capturing range of camera 110. Alternatively, angle adjustment mechanism 111 may not be provided and, in this case, the user may adjust the angle of camera 110 by himself/herself in the angle adjustment mode. Thus, in the angle adjustment mode, the output of camera 110 can be displayed directly on first display unit 120 and, therefore, it is very convenient that the angle of camera 110 can be adjusted while viewing the video captured by camera 110 and that efforts and waiting time to record and reproduce the images can be eliminated.

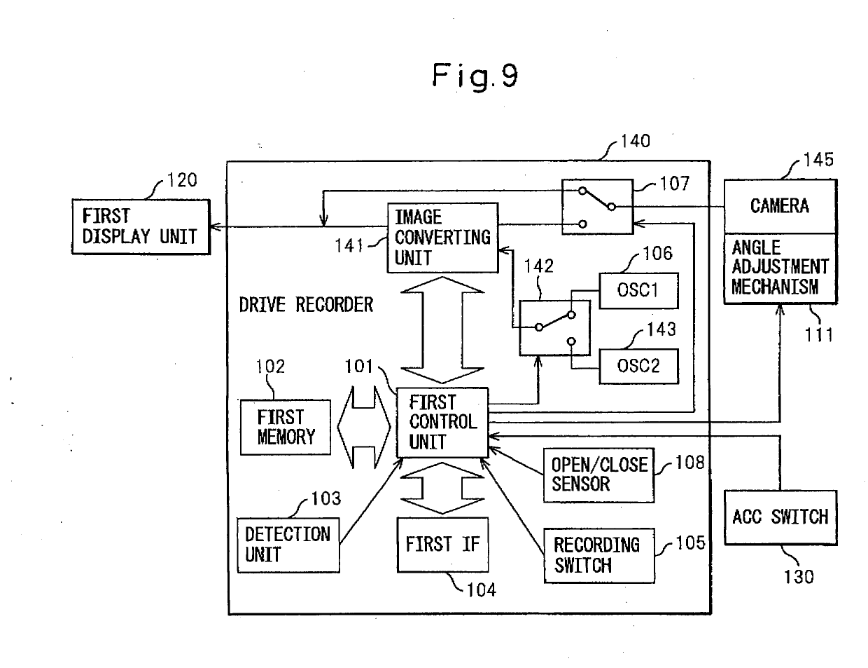

FIG. 9 is a diagram illustrating a schematic configuration of a variation of the system illustrated in FIG. 1.

The system illustrated in FIG. 9 differs from that illustrated in FIG. 1 in that the system illustrated in FIG. 9 employs a camera 145 that is adaptable to an LED traffic light, and therefore has a first frequency oscillator 106 that outputs a first clock frequency corresponding to the standard video signal, a second frequency oscillator 143 that outputs a second clock frequency to adapt to the LED traffic light, and a frequency changeover switch 142 for switching between the first clock frequency from first frequency oscillator 106 and the second clock frequency from second frequency oscillator 142. In FIG. 9, the elements same as those in FIG. 1 are designated by like reference numbers and their description is omitted. Further, in the system illustrated in FIG. 9, memory card 10 and center terminal 200 are same as those of FIG. 1 and, therefore, their description is omitted.

Hereinafter, the camera and the clock frequency adaptable to the LED traffic light will be described.

Since the power used to operate the LED traffic light is produced by full-wave rectifying the commercial power, the voltage applied to the LEDs for displaying colors (green, red, yellow and the like) of the LED traffic light varies at twice the frequency of the commercial power, i.e., at 100 Hz in eastern Japan and at 120 Hz in western Japan. Further, LEDs do not illuminate unless a voltage of a predetermined level or more is applied and the LED traffic light is designed to illuminate when a voltage of about one half or more of the supply voltage is applied. Therefore, the LED traffic light illuminates by flashing on and off at twice the frequency of the commercial power.

A typical CCD camera, for example, camera 110 illustrated in FIG. 1 captures images at the standard video signal frequency or, in other words, a frequency (59.94 Hz) according to the NTSC (National Television System Committee) standard and outputs the video signal corresponding-to the captured images. Further, a typical monitor, for example, first display unit 120 illustrated in FIG. 1 is designed to display the video signal at the standard video signal frequency of the NTSC standard.

In these circumstances, when images of the LED traffic light are captured by the typical CCD camera, there can occur cases in which the colors of the traffic light is unrecognizable in the captured images because of the relationship between the flashing frequency (120 Hz or 100 Hz) and the video capture frequency of the CCD camera (59.94 Hz). The reason for this will be described below.

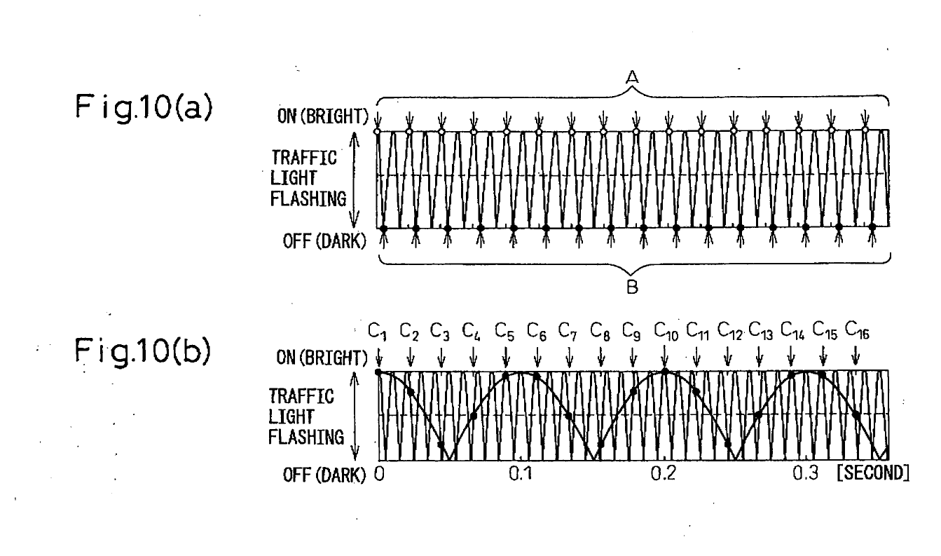

FIGS. 10(a) and 10(b) are diagram illustrating relationships between the traffic light flashing and the image capture timing.

FIG. 10(a) illustrates the case in which images of the traffic light flashing on and off at 100 Hz are captured with the capture timing of 50 Hz. In the figure, “A” indicates the timing when the images are captured when the traffic light is the brightest, and “B” indicates the timing when the images are captured when the traffic light is the darkest. That is, in the case of “A”, the color of the traffic light is recognizable in all the captured images, but in the case of “B”, the color of the traffic light is recognizable in none of the captured images. That is, when the flashing frequency of the traffic light coincides with an integral multiple of the image capture frequency, there occur circumstances, as indicated by “B”, in which the color of the traffic light is unrecognizable, no matter how many images are captured.

FIG. 10(b) illustrates the case in which images of the traffic light flashing on and off at 100 Hz are captured with the timing of 45 Hz and C₁ to C₁₆ indicate the image capture timing instants In this case, since the flashing frequency of the traffic light deviates from an integral multiple of the image capture frequency, the traffic light in the captured images flashes on and off at a frequency fb (Hz). For example, in the images captured at C₁, C₂, C₅, C₆, C₉, C₁₀, C₁₁, C₁₄, and C₁₅, the color of the traffic light is recognizable.

Assuming that the image capture frequency is fr (Hz), the relationship between the flashing frequency fs (Hz) of the traffic light and the flashing frequency fb (Hz) of the traffic light in the captured images is defined by the following equation (1),

fb=|fs−fr×n| (1)

(where n is an integer with which fr×n is closest to fs.)

For example, when equation (1) is applied to the case illustrated in FIG. 10(b), fb=(100−45×2)=10 (Hz), which means that the traffic light in the captured images flashes on and off at 1/10 (s) intervals.

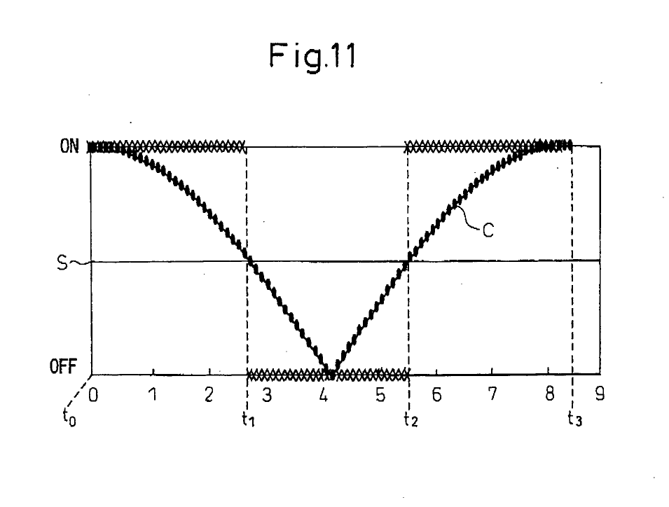

FIG. 11 is a diagram illustrating an example of a flashing state of a traffic light in captured images.

FIG. 11 illustrates the case in which an LED traffic light flashing on and off at 120 Hz in western Japan is captured by the CCD camera at the standard video signal frequency (59.94 Hz) of the NTSC standard. In the figure, the ordinate represents the voltage applied to the LED traffic light and it is assumed here that when a voltage higher than or equal to a threshold voltage S corresponding to one half of the supply voltage is applied, the LED illuminates and the color of the traffic light is recognizable but, when a voltage lower than the threshold voltage S is applied, the LED does not illuminate sufficiently and the color of the traffic light becomes unrecognizable. On the other hand, in the figure, the abscissa represents the time (s). Further, curve C is a plot, as a function of time, of the voltage applied to the LED traffic light at the image capture timing.

In the case of FIG. 11, the flashing frequency of the traffic light in the captured images is 0.12 (Hz) from equation (1), and the flashing cycle is about 8.33 seconds. This means that the curve C cycles on and off in about every 8.33 seconds. In FIG. 11, during the period from time t0 to time t1 and the period from time t2 to time t3, since the applied voltage is higher than or equal to the threshold voltage S, the LED illuminates and the color of the traffic light is recognizable. On the other hand, during the period from time t1 to time 2 in FIG. 11, since the applied voltage is lower than the threshold voltage S the LED does not illuminate sufficiently and the color of the traffic light becomes unrecognizable. That is, throughout the period from time t1 to time 2, which lasts about 2.8 seconds (that is to say, about one third of the flashing cycle), the color of the traffic light cannot be recognized. In particular, if the period from time t1 to time t2 (2.8 s) overlaps the ON period of the yellow light, the yellow light may be unrecognizable. In this case, for example, it is not possible to determine whether the traffic light was showing yellow or red when the vehicle entered an intersection and the situation at that moment cannot be grasped completely.

In this way, when images of an LED traffic light are captured by the CCD camera and the like of the drive recorder and the like, there can occur cases in which the color of the traffic light is not recognizable in the captured images, depending on the relationship between the flashing frequency of the traffic light and the image capture timing. This problem occurs in western Japan (120 Hz) when the video camera is based on the NTSC standard (59.94 Hz) and in eastern Japan (100 Hz) when the video camera is based on the PAL standard (50 Hz).

As illustrated by equation (1), the traffic light in the captured images repeats flashing on and off with a flashing cycle of 1/fb (s). The problem here is the occurrence of a period throughout which the color of the traffic light becomes unrecognizable for an extended period of time. Considering that the voltage waveform applied to the LED is sinusoidal and that the color of the LED traffic light becomes recognizable when a voltage higher than or equal to one half of the supply voltage is applied, it is thought that the period throughout which the color of the traffic light is unrecognizable corresponds to one third of the flashing cycle.

Of the three colors, red, yellow, and green, used in LED traffic lights, the ON period of the yellow light is the shortest at about 2 seconds. Accordingly, if the color of the traffic signal is to be recognized correctly, one third of the flashing cycle (that is, the OFF period from t1 to t2 such as illustrated in FIG. 11) must be made at least shorter than the ON period of the yellow LED. If the ON period of the yellow LED is 2 seconds, then from equation (1) it is possible to determine the image capture frequency fr (Hz) that satisfies the relationship 1/(3 fb)≦2. Since the traffic light flashing frequency fs is 100 (Hz) in eastern Japan and 120 (Hz) in western Japan, the relationship 1/(3 fb)≦2 must be satisfied for both of the flashing frequencies fs.

That is, the image capture frequency fr that satisfies both of the following equations (2) and (3) is the frequency not affected by the LED traffic light flashing:

|100−fr×n|=fb≧⅙ (2)

|120−fr×n|=fb≧⅙ (3)

Accordingly, the image capture frequency fr should be chosen so that fr≧60.06 (Hz), 59.94 (Hz)≧fr≧50.06 (Hz), or fr≦49.94 (Hz).

In view of the above, in this embodiment, 59.5 Hz is defined as the frequency adaptable to the LED traffic light and the CCD camera whose image capture frequency fr is 59.5 Hz is used as camera 145 adaptable to the LED traffic light. In this case, according to equation (3), since the flashing frequency fb is 1 Hz and the flashing cycle is 1 second, the OFF period is about 0.3 seconds that is one third of the flashing cycle. Similarly, according to equation (2), the OFF period is 0.02 seconds. As a result, every color used in the LED traffic light becomes recognizable in the captured images, either in eastern Japan or in western Japan. Accordingly, the first frequency corresponding to the first frequency oscillator 106 is chosen to be the standard video signal frequency (59.4 Hz) of the NTSC standard, and the second frequency of the second frequency oscillator 143 is selected to be 59.5 Hz.

The above equations (2) and (3) are defined for the case in which the frequency not affected by the LED traffic light flashing is determined so that the period throughout which the color of the traffic light becomes unrecognizable is held shorter than or equal to the ON period of the yellow LED, i.e., 2 seconds, and it is to be understood that the range that fr can take varies depending on how the period throughout which the color of the traffic light becomes unrecognizable is determined.

In drive recorder 140 illustrated in FIG. 9, when changeover switch 107 is switched to image converting unit 141 to read the still images, frequency changeover switch 142 is also changed so that image converting unit 141 can use the second clock frequency (the frequency adaptable to the LED traffic light) from second frequency oscillator 143. As a result, image converting unit 141 can create the still image data from the video signal from camera 145 adaptable to the LEb traffic light and record it in first memory 102 in a circulating and continuous manner.

Further, in drive recorder 140 illustrated in FIG. 9, in the reproduction moder the frequency changeover switch 142 can be switched so that image converting unit 141 can use the first clock frequency (the standard video signal frequency of the NTSC standard) from first frequency oscillator 106. As a result, image converting unit 141 can convert the still image data recorded in memory card 10 into the standard video signal of the NTSC standard and output it to first display unit 120 Also in drive recorder 140 illustrated in FIG. 9, two independent image converting units 141 may be provided for performing the recording and reproducing functions, respectively. In this case, the second frequency oscillator 143 may be connected to the image converting unit for recording and the first frequency oscillator 106 may be connected to the image converting unit for reproduction, and therefore, changeover switch 142 becomes unnecessary.

Still further, in drive recorder 140 illustrated in FIG. 9, in the angle adjustment mode, changeover switch 107 can be switched to directly output the video signal from camera 145 adaptable to the LED traffic light to first display unit 120 according to the NTSC standard.

When the video signal from camera 145 adaptable to the LED traffic light is directly output to first display unit 120 according to the NTSC standard, the video images are disturbed and the colors are expressed inaccurately in some degree, but the situation in the video images can be grasped and the angle adjustment is not significantly obstructed. Therefore, also when drive recorder 140 and camera 145 adaptable to the LED traffic light are used, similarly to the system illustrated in FIG. 1, the angle of camera 145 can be adjusted easily and appropriately.

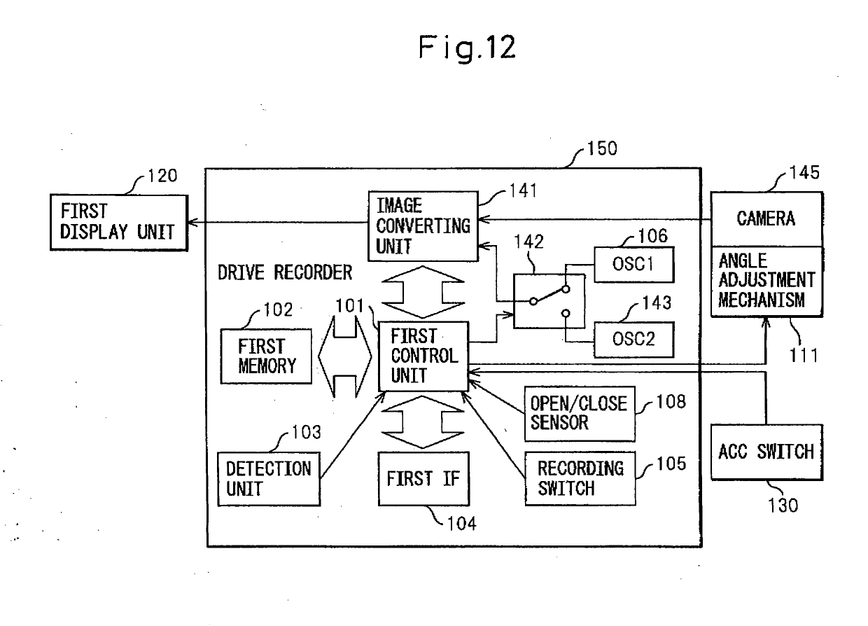

FIG. 12 is a diagram illustrating a schematic configuration of another system including a drive recorder according to the present invention.

The system illustrated in FIG. 12 differs from that illustrated in FIG. 9 in that drive recorder 150 in the system illustrated in FIG. 12 does not have changeover switch 107 illustrated in FIG. 9 and, therefore, there is no path through which the video signal from camera 145 is directly output to first display unit 120. In FIG. 12, the elements same as those in FIG. 9 are designated by like reference numbers and their description is omitted. Further, memory card 10 and center terminal 200 in the system illustrated in FIG. 12 are similar to those illustrated in FIG. 1 and, therefore, their description is omitted. Still further, also in FIG. 12, camera 145 adaptable to the LED traffic light is used, and similarly, the second clock frequency output from second frequency oscillator 143 is the clock frequency (59.5 Hz) adaptable to the LED traffic light, First display unit 120 is a monitor of the NTSC standard.

Drive recorder 150 illustrated in FIG. 12 has a further effect that its configuration can be simplified because changeover switch 107 for providing the path for directly input the video output from the camera to the display unit becomes unnecessary.

The main process flow of drive recorder 150 illustrated in FIG. 12 is similar to that corresponding to drive recorder 100 illustrated in FIG. 5 and its description is omitted.

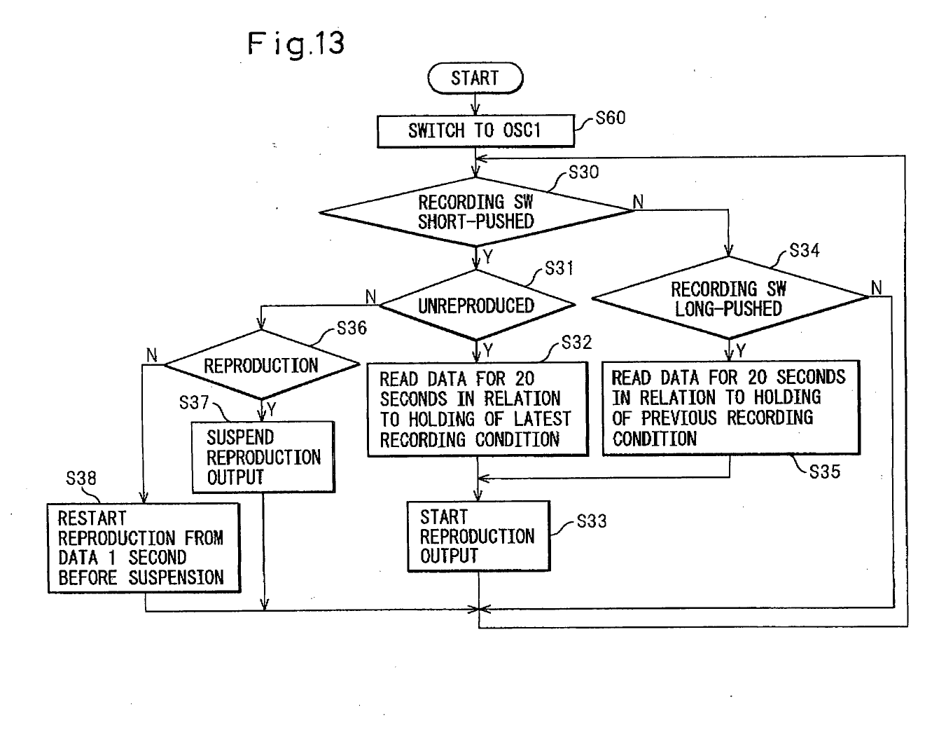

FIG. 13 is a diagram illustrating an example of a process flow in the reproduction mode corresponding to drive recorder 150 illustrated in FIG. 12.

In the reproduction mode illustrated in FIG. 13, the process in S15 of FIG. 5 is described in more detail. The process flow illustrated in FIG. 13 differs from that illustrated in FIG. 6 only in that first control unit 101 first controls frequency changeover switch 142 so that the first clock frequency from first frequency oscillator 106 can be used in image converting unit 141 (S60). All other steps S30-S38 are similar to those illustrated in FIG. 6 and their description is omitted. As a result, in drive recorder 150, image converting unit 141 converts the still image data recorded in memory card 10 into the video signal corresponding to the standard frequency and outputs it to the first display unit 120.

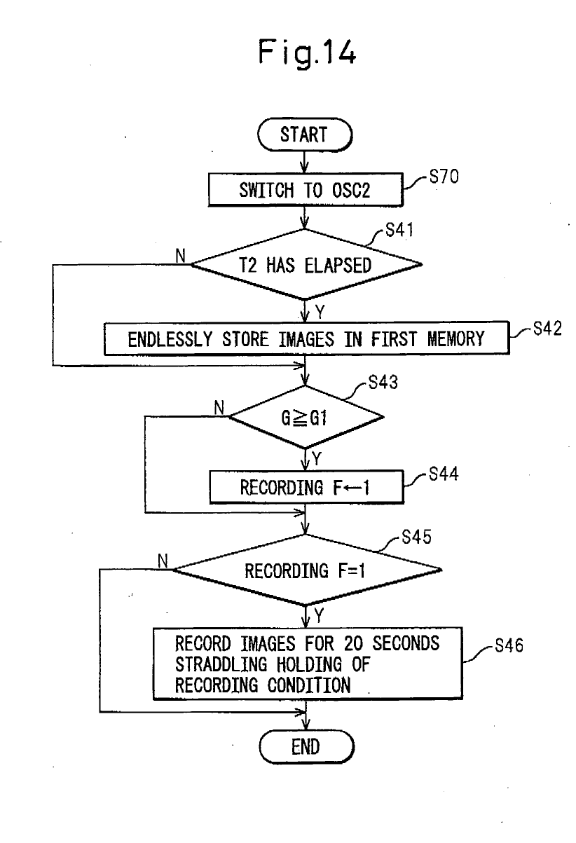

FIG. 14 is a diagram illustrating an example of a process flow in the normal operation mode corresponding to drive recorder 150 illustrated in FIG. 12.

In the normal operation mode illustrated in FIG. 14, the process in S25 of FIG. 5 is described in more detail. The process flow illustrated in FIG. 14 differs from that illustrated in FIG. 7 only in that first control unit 101 first controls frequency changeover switch 142 so that the second clock frequency from second frequency oscillator 143 can be used in image converting unit 141 (370). All other steps S41-S46 are similar to those illustrated in FIG. 7 and their description is omitted. As a result, in drive recorder 150, image converting unit 141 converts the video signal from camera 145 adaptable to the LED traffic light into the still image data at the frequency for the LED traffic light and records it in first memory 102 in a circulating and continuous manner. Further, in drive recorder 150, when the recording condition holds, the still image data for 20 seconds straddling the holding of the recording condition is recorded in memory card 10.

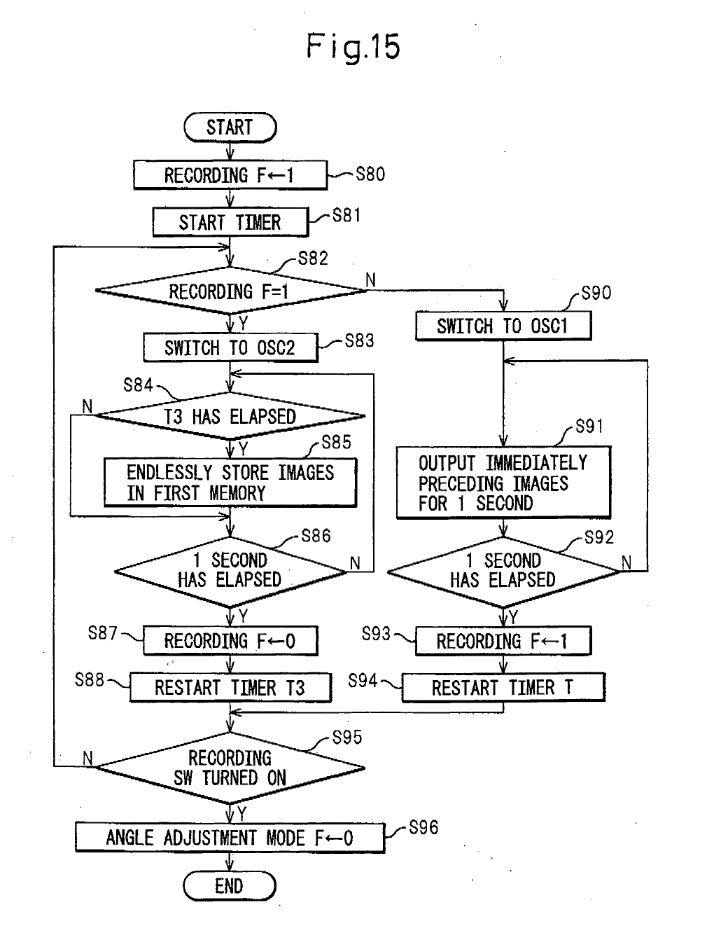

FIG. 15 is a diagram illustrating an example of a process flow in the angle adjustment mode corresponding to drive recorder 150 illustrated in FIG. 12.

In the angle adjustment mode illustrated in FIG. 15, the process in S26 of FIG. 5 is described in more detail. First, first control unit 101 sets the recording F to “1” (S80) and starts the timer (S81).

Next, first control unit 101 determines whether the recording F is “1” or not (S82) and, if the recording F is “1”, controls frequency changeover switch 142 so that the second frequency clock is output from second frequency oscillator 143 to image converting unit 141 (S83).

Next, first control unit 101 determines whether a timer time T3 has elapsed or not (S84) and, if timer time T3 has elapsed, image converting unit 141 converts the analog video data from camera 145 into the digital still image data of the JPEG standard and stores it in first memory 102 in a circulating and continuous manner (S85). Timer time T3 corresponds to timing for capturing the images. For example, when data for 10 still images per second is recorded in first memory 102, timer time T3 is set to 100 ms and it is determined whether the image capture has been performed or not in S84. Thus, in this case, in drive recorder 100, data for 10 still images per second is recorded in first memory 102 in a circulating and continuous manner.

Next, first control unit 101 determines whether 1 second has elapsed or not after the timer was started (S86) and, if 1 second has elapsed, the recording F is set to “0” (S87). In other words, until 1 second has elapsed, the analog video data from camera 145 is converted into the digital still image data of the JPEG standard and recorded in first memory 102 in a circulating and continuous manner,

Next, first control unit 101 restarts the timer (S88).

If the recording F is not “1” in S82, first control unit 101 controls frequency changeover switch 142 so that the first frequency clock is output from first frequency oscillator 106 to image converting unit 141 (S90) and image converting unit 141 converts the immediately preceding image data recorded in first memory 102 into the video signal according to the standard video frequency and outputs it to first display unit 120 (S91).

Next, first control unit 101 determines whether 1 second has elapsed or not after the timer was started (S92), and if 1 second has elapsed, the recording F is set to “1” (S93). In other words, until 1 second has elapsed, the still image data for the immediately preceding 1 second recorded in first memory 102 in S85 is output to first display unit 120.

Next, first control unit 101 restarts the timer (394).

Next, first control unit 101 determines whether recording switch 105 is ON or not and, if recording switch 105 is OFF, the process returns to 382 (S95). The process (S96) when it is determined that recording switch 105 is ON in S95 is similar to 352 illustrated in FIG. 8 and its description is omitted. Thus, also in the process flow illustrated in FIG. 15, when recording switch has been turned ON within the time period after the ACC switch 130 had been turned ON for the first time till timer T1 was up (10 seconds in the process flow in FIG. 5), the process enters the angle adjustment mode and, when recording switch 105 is turned ON again after entering the angle adjustment mode (see S95), the angle adjustment mode terminates.

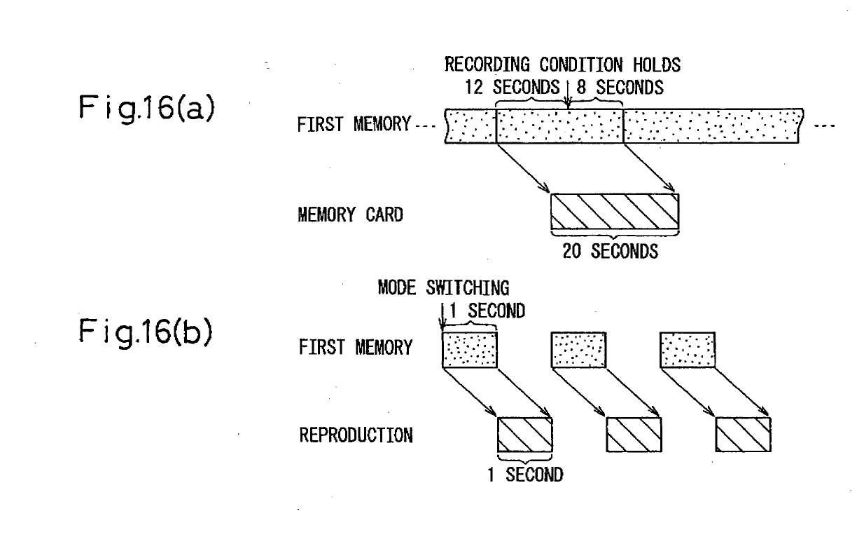

FIGS. 16(a) and 16(b) are diagrams describing the video reproduction in the angle adjustment mode corresponding to drive recorder 150 illustrated in FIG. 12.

FIG. 16(a) is a diagram schematically illustrating the image data recorded in memory card 10 when the recording condition holds in the normal operation mode. As described above, the still image data is recorded in first memory 102 in a circulating and continuous manner and, when the recording condition holds, the image data for 12 seconds before and 8 seconds after the holding of the recording condition is recorded in memory card 10.

FIG. 16(b) is a diagram schematically illustrating the image data reproduced according to the process flow illustrated in FIG. 15. After entering the angle adjustment mode, during 1 second defined in S86, the still image data recorded in first memory 102 for the subsequent 1 second defined in S92 is output to the first display unit 120 to be reproduced.

Thus, in drive recorder 150 illustrated in FIG. 12, after entering the angle adjustment mode, the video of camera 145 can be reproduced at intervals of 1 second and, in this mode, angle adjustment mechanism 111 can be operated by using buttons or touch-sensitive input means and the like (not illustrated) provided in the drive recorder so as to appropriately adjust the capturing range of camera 145. Alternatively, angle adjustment mechanism 111 may not be provided and, in this case, the user may adjust the angle of camera 110 by himself/herself in the angle adjustment mode. Thus, in the angle adjustment mode in drive recorder 150 illustrated in FIG. 12, the output of camera 145 can be displayed on first display unit 120 intermittently for a shorter time period than the recording time of 20 seconds in the normal operation mode, and therefore it is very convenient that the angle of camera 145 can be adjusted while viewing the video captured by camera 145 and that waiting time to record and reproduce the images can be eliminated. Moreover, also in the angle adjustment mode, the angle can be adjusted with high workability while viewing clear video according to the NTSC standard. The time interval of 1 second defined in S86 and S92 is merely an example and any time interval may be selected so long as it is shorter than the recording time when the recording condition holds in the normal operation mode. As the intermittent time interval becomes shorter, the waiting time mentioned above is also reduced and the convenience is improved. Still further, in drive recorder 150 illustrated in FIG. 12, the camera that cannot adapt to the LED traffic light may alternatively be used. In this case, though it is impossible to adapt to the LED traffic light, the angle adjustment can be performed more conveniently, and further, the configuration can be simplified because frequency changeover switch 142, second frequency oscillator 143 as well as the process in relation to the switching between the first and second frequency oscillators become unnecessary.

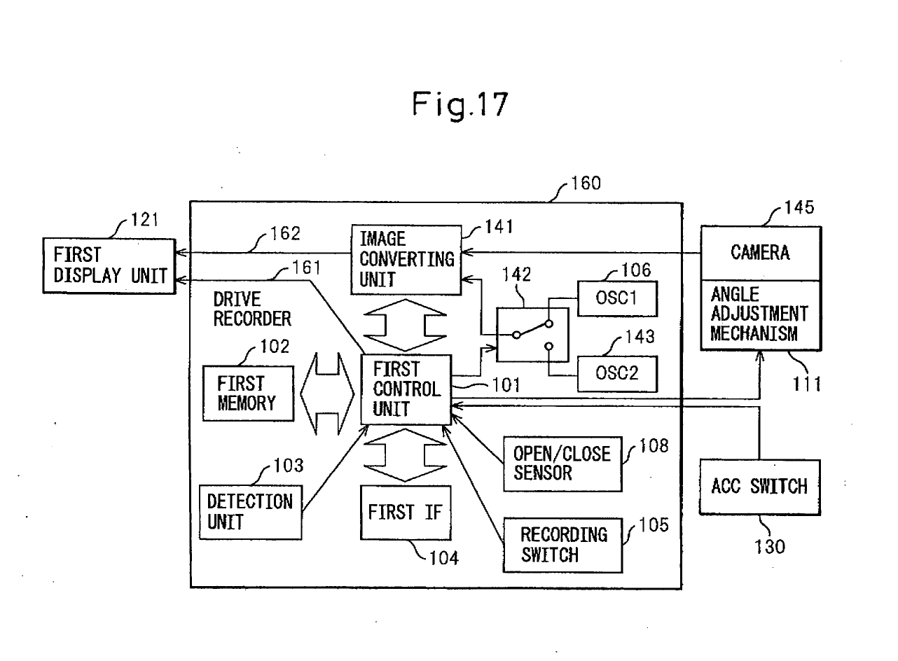

FIG. 17 is a diagram illustrating a schematic configuration of yet another system including a drive recorder according to the present invention.

The system illustrated in FIG. 17 differs from that illustrated in FIG. 12 only in that, in the system illustrated in FIG. 17, drive recorder 160 is configured so that it can output the still image data 161 (digital data) recorded in first memory 102 directly to the outside and in that first display unit 121 has input terminals or input interfaces not only for the analog video but also for digital still image data 161. In FIG. 17, the elements same as those in FIG. 12 are designated by like reference numbers and their description is omitted. Further, memory card 10 and center terminal 200 in the system illustrated in FIG. 17 are similar to those illustrated in FIG. 1 and, therefore, their description is omitted. Still further, also in FIG. 17, camera 145 that is adaptable to the LED traffic light is used and, similarly, the second clock frequency output from second frequency oscillator 143 is the clock frequency (59.5 Hz) adaptable to the LED traffic light. First display unit 121 is a monitor of the NTSC standard.

Drive recorder 160 illustrated in FIG. 17 also has a further effect that its configuration can be simplified because changeover switch 107 illustrated in FIG. 9 for providing the path for directly input the video output from the camera to the display unit becomes unnecessary.

The main process flow of drive recorder 160 illustrated in FIG. 17 is similar to that corresponding to drive recorder 100 illustrated in FIG. 5 and the process flow of the reproduction mode is similar to that corresponding to drive recorder 150 illustrated in FIG. 13 and the process flow of the normal operation mode is similar to that corresponding to drive recorder 150 illustrated in FIG. 14, and therefore their description is omitted.

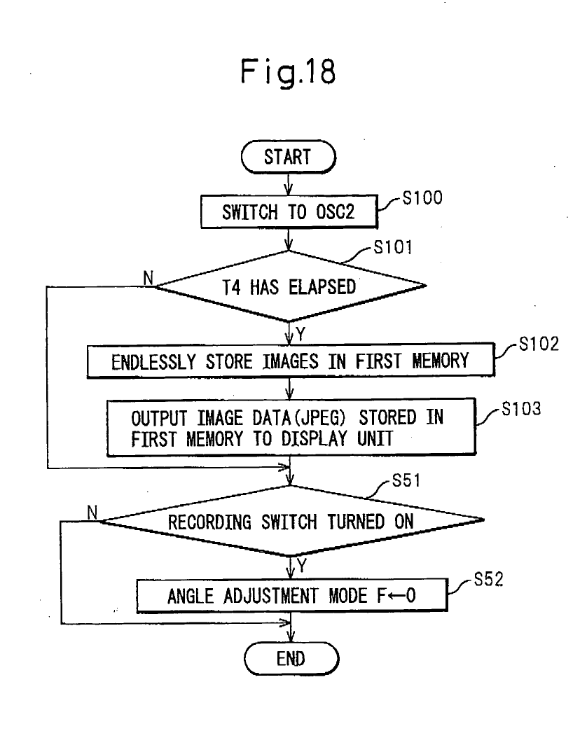

FIG. 18 is a diagram illustrating an example of a process flow in the angle adjustment mode corresponding to drive recorder illustrated in FIG. 17.

In the angle adjustment mode illustrated in FIG. 18, the process in S26 of FIG. 5 is described in more detail. First, first control unit 101 controls frequency changeover switch 142 so that the second clock frequency is output from second frequency oscillator 143 to image converting unit 141 (S100).

Next, first control unit 101 determines whether a timer time T4 that was started at a predetermined timing has elapsed or not (S101) and, if timer time T4 has elapsed, image converting unit 141 converts analog video data from camera 145 into digital still image data of the JPEG standard and stores it in first memory 102 in a in a circulating and continuous manner (S102). Timer time T4 corresponds to the timing for capturing the images. For example, when data for 10 still images per second is recorded in first memory 102, timer time T4 is set to 100 ms, and when data for 30 still images per second is recorded in first memory 102, timer time T4 is set to 33 ms. Thus, in these cases, in drive recorder 160, data for 10 (or, for example, 30) still images per second is recorded in first memory 102 in a circulating and continuous manner.

Next, first control unit 101 outputs the still image data recorded in first memory 102 in S102 directly to first display unit 121 (3103).

Here, S51 and S52 following S103 are similar to those illustrated in FIG. 8 and their description is omitted. Thus, also in the process flow illustrated in FIG. 18, when recording switch 105 has been turned ON within the time period after the ACC switch had been turned ON for the first time till timer T1 was up (10 seconds in the process flow in FIG. 5), the process enters the angle adjustment mode, and when recording switch 105 is turned ON again after entering the angle adjustment mode (see S51), the angle adjustment mode terminates.

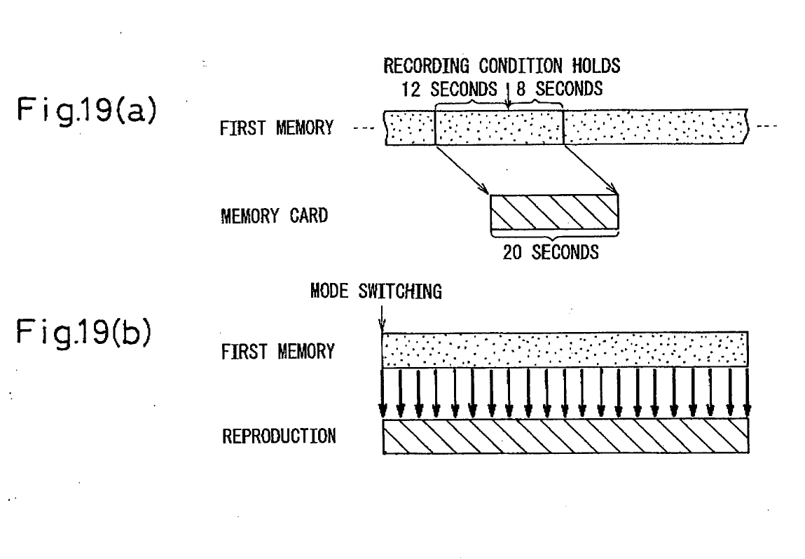

FIGS. 19(a) and 19(b) are diagrams for describing video reproduction in the angle adjustment mode corresponding to drive recorder 160 illustrated in FIG. 17.

FIG. 19(a) is a diagram schematically illustrating the image data recorded in memory card 10 when the recording condition holds in the normal operation mode and it is similar to FIG. 16(a), and therefore its description is omitted.

FIG. 19(b) is a diagram schematically illustrating the image data reproduced according to the process flow illustrated in FIG. 18. After entering the angle adjustment mode, the still image data recorded in first memory 102 is output directly from first memory 102 to first display unit 121 to be reproduced every timer time T4 defined in S101 and this process is repeated at intervals of timer time T4. Because timer time T4 (for example, 100 ms or 33 ms) is a very short interval, the user feels that the still images are changed instantaneously.

Thus, in drive recorder 160 illustrated in FIG. 17, after entering the angle adjustment mode, the video of camera 145 can be reproduced at intervals of timer time T4 and, in this mode, angle adjustment mechanism 111 can be operated, for example, by using buttons or touch-sensitive input means and the like (not illustrated) provided in the drive recorder so as to appropriately adjust the capturing range of camera 145. Alternatively, angle adjustment mechanism 111 may not be provided and, in this case, the user may adjust the angle of camera 145 by himself/herself in the angle adjustment mode. Thus, in the angle adjustment mode in drive recorder 160 illustrated in FIG. 17, the output of camera 145 can be displayed on first display unit 121 intermittently and in real time and, therefore, it is very convenient that the angle of camera 145 can be adjusted while viewing the video captured by camera 145 and that efforts and waiting time to record and reproduce the images can be eliminated. Moreover, also in the angle adjustment mode, the angle can be adjusted with high workability while viewing clear video according to the NTSC standard. Still further, in drive recorder 160 illustrated in FIG. 17, the camera that cannot adapt to the LED traffic light may alternatively be used. In this case, though it is impossible to adapt to the LED traffic light, the angle adjustment can be performed more conveniently and, further, the configuration can be simplified because frequency changeover switch 142, second frequency oscillator 143 as well as the process in relation to the switching between the first and second frequency oscillators become unnecessary.

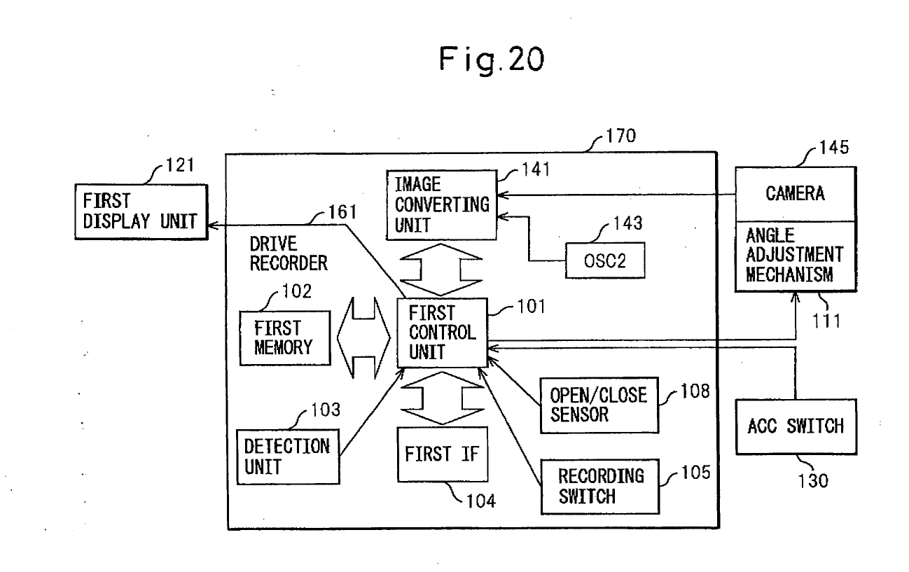

FIG. 20 is a diagram illustrating a schematic configuration of a variation of the system illustrated in FIG. 17.

The system illustrated in FIG. 20 differs from that illustrated in FIG. 17 only in that, in the system illustrated in FIG. 20, drive recorder 170 does not have frequency changeover switch 142 and first frequency oscillator 106 and it is configured to output only still image data 161 (digital data) recorded in first memory 102 to first display unit 121 directly. Thus, in drive recorder 170 illustrated in FIG. 20, analog video information data 162 is not output to first display unit 121. In FIG. 20, the elements same as those in FIG. 17 are designated by like reference numbers and their description is omitted. Further, memory card 10 and center terminal 200 in the system illustrated in FIG. 17 are similar to those illustrated in FIG. 1 and, therefore, their description is omitted. Still further, also in FIG. 20, camera 145 adaptable to the LED traffic light is used, and similarly, the second clock frequency output from second frequency oscillator 143 is the clock frequency (59.5 Hz) adaptable to the LED traffic light. First display unit 121 is a monitor of the NTSC standard.

In drive recorder 170 illustrated in FIG. 20, when the reproduction is performed in first display unit 121 (in the reproduction mode and the angle adjustment mode), the digital still image data recorded in first memory 102 is always output directly. Therefore, in drive recorder 170 illustrated in FIG. 20, in addition to the effect of the drive recorder 160 illustrated in FIG. 17, drive recorder 170 illustrated in FIG. 20 has a further effect that its configuration can be simplified further because changeover switch 107 for providing the path for directly input the video output from the camera to the display unit, frequency changeover switch 142 and first frequency oscillator 106 become unnecessary.

What is claimed is:

1. A drive recorder for recording images captured by a camera in a recording medium, comprising:
mode selection means for selecting an angle adjustment mode of the camera; and
a control unit for controlling so that image data based on said images is output to a display unit when said mode selection means selects the angle selection mode.

2. A drive recorder according to claim 1, further comprising a switching unit for switching and outputting the images captured by the camera directly to the display unit, wherein, when said mode selection means selects the angle adjustment mode, said control unit controls said switching unit to output said image data to the display unit.

3. A drive recorder according to claim 1, further comprising: a converting unit for converting the images captured by the camera into data to be recorded; and a memory for recording said data, wherein, when said mode selection means selects the angle adjustment mode, said control unit records the data that is converted by said converting unit in said memory, and converts the data recorded in said memory into output data compatible with the display unit and outputs it to the display unit.

4. A drive recorder according to claim 3, wherein said memory is said recording medium.

5. A drive recorder according to claim 3, wherein said memory is different from said recording medium.

6. A drive recorder according to claim 3, wherein said images are based on video data captured by using a frequency that is not affected by flashing of an LED traffic light due to a commercial power frequency,

7. A drive recorder according to claim 1, further comprising: a converting unit for converting the images captured by the camera into data to be recorded; and a memory for recording said data, wherein, when said mode selection means selects the angle adjustment mode, said control unit records the data that is converted by said converting unit in said memory, and outputs the data recorded in said memory to the display unit.

8. A drive recorder according to claim 7, wherein said memory is said recording medium.

9. A drive recorder according to claim 7, wherein said memory is different from said recording medium.

10. A drive recorder according to claim 7, wherein said images are based on video data captured by using a frequency that is not affected by flashing of an LED traffic light due to a commercial power frequency.

11. A system comprising;
a camera for capturing images by using a frequency that is not affected by flashing of an LED traffic light due to a commercial power frequency;
a display unit that operates based on a standard frequency; and
a drive recorder for recording the images captured by said camera in a recording medium,
wherein said drive recorder comprises:
mode selection means for selecting an angle adjustment mode of said camera; and
a control unit for controlling so that image data based on said images is output to said display unit when said mode selection means selects the angle selection mode.
